(19) United States
(12) Patent Application Publication
(10) Pub. No.: US 2019/0380354 A1
(43) Pub. Date: Dec. 19, 2019

(54) METHOD OF PROVIDING PROCESSED MARINE PRODUCT FOR REFRIGERATION STORAGE

(71) Applicant: SENREI CO., LTD., Miyagi (JP)

(72) Inventors: Akihiko Oka, Miyagi (JP); Futoshi Oi, Miyagi (JP)

(21) Appl. No.: 16/089,636

(22) PCT Filed: Mar. 27, 2017
(86) PCT No.: PCT/JP2017/012344

§ 371 Date: Sep. 28, 2018

(30) Foreign Application Priority Data
Mar. 31, 2016 (JP) 2016-071234

(51) Int. Cl. A23B 4/06; A23B 4/16; B65D 85/50

(52) U.S. Cl. CPC A23B 4/066; A23V 2002/00; B65D 85/50; A23B 4/16

(57) ABSTRACT

The present invention relates to a method of providing a processed marine product for refrigeration storage, the method being characterized by directly storing a refrigerated processed marine product in a container made of a plastic material having a transparency to allow the amount of the refrigerated processed marine product stored therein to be visually recognized from the outside, without packaging the product in a plastic bag or the like, and supplying the product to a consumer.

### TECHNICAL FIELD

The present invention relates to a method of providing a processed marine product for refrigeration storage. More particularly, the present invention relates to a method of providing a processed marine product for refrigeration (freezing) storage, including not placing the refrigerated processed marine product in a bag and the like, in which conventionally, the refrigerated processed marine product was stored in a bag such as a plastic bag which is then placed in a box (decorative box) again to be double packed/wrapped, and sold, and a consumer who purchased the product (user) took the refrigerated processed marine product out of the plastic bag and the like and transferred the product into another container for storage which was then stored/preserved in a refrigerator (freezer), but directly storing the refrigerated processed marine product in a container which combines both functions of a container for sale and a container for refrigeration storage, and also allows the content to be visually confirmed, and supplying the product to a consumer.

### BACKGROUND ART

Recently, as a refrigeration (freezing) storage technology, a cell alive system (CAS) method (Patent Literature 1) has been suggested. According to the CAS refrigerating method, freshness and taste (good taste) of a processed marine product are maintained over a long period of time. However, there is a problem to be improved in the method of providing the processed marine product for preserving refrigeration by storing the refrigerated processed marine product in a container as such, and distributing and supplying the product.

For example, refrigerated processed scallop adductor muscles for commercial use (commonly called, scallops) are sold, usually in a state where about 1 kg of the scallops is placed in a plastic bag for storage, which is placed in a decorative box, and used for a sashimi of a restaurant or a side dish corner of a supermarket as a user. The user takes the plastic bag out of the decorative box, takes the scallops out of the plastic bag again and transfers them to another container, and then uses them. The decorative box with the plastic bag taken out, and the plastic bag with the scallops taken out are usually discarded. Since the plastic bag or the decorative box is not appropriate for storage, the plastic bag and the decorative box are only used in the distribution stage.

The scallop adductor muscles are transferred to a container made of metal (metal tray) for refrigeration storage, stored in a refrigerated stocker, and appropriately thawed and used, by the user. In addition, since in the distribution stage, the amount in a storage box unit is transferred to the storage container as it is and used, the opened amount should be used up as soon as possible. In addition, since the storage container is mostly made of metal and opaque, it is not easy to confirm the residual amount which is placed in the stocker.

### CITATION LIST

### Patent Literature

Patent Literature 1: JP 4041673 B2 (US6250087)

### SUMMARY OF INVENTION

### Technical Problem

However, since a person who handles the refrigerated processed marine product (hereinafter, referred to as a person skilled in the art) is familiar with the above-described container, a person skilled in the art does not currently feel dissatisfaction about usability of the container, and the like.

An issue was raised for the above-mentioned situation awareness of a person skilled in the art, and it is an object of the present invention to provide a method of directly storing a processed marine product for refrigeration storage in a container which is more convenient to use, combines both functions of a container for sale and a container for refrigeration storage, and also allows the content to be visually confirmed, and supplying the product.

### Solution to Problem

The present invention relates to a method of providing a processed marine product for refrigeration storage of the following [1] to [10]:
[1] A method of providing a processed marine product for refrigeration storage, the method including: directly storing a refrigerated processed marine product in a container formed of a plastic material, having a transparency to allow an amount of the refrigerated processed marine product stored therein to be visually recognized from outside, and supplying the product to a consumer, wherein the refrigerated processed marine product is stored in a freezer, and thawed for use.
[2] A method of providing a processed marine product for refrigeration storage, the method including: directly storing a refrigerated processed marine product in a container formed of a plastic material of a cold-resistant grade, having a transparency to allow an amount of the refrigerated processed marine product stored therein to be visually recognized from outside, and supplying the product to a consumer, wherein the refrigerated processed marine product is stored in a freezer, and thawed for use.
[3] A method of providing a processed marine product for refrigeration storage, the method including: directly storing a refrigerated processed marine product in a container formed of a plastic material having an embrittlement temperature less than −5° C., having a transparency to allow an amount of the refrigerated processed marine product stored therein to be visually recognized from outside, and supplying the product to a consumer, wherein the refrigerated processed marine product is stored in a freezer, and thawed for use.
[4] The method of providing a processed marine product for refrigeration storage according to any one of [1] to [3], wherein the refrigerated processed marine product is directly stored in the container formed of the plastic material, and the container is filled with nitrogen by gas substitution packaging, and supplied to a consumer.
[5] The method of providing a processed marine product for refrigeration storage according to any one of [1] to [4], wherein the plastic material is selected from polyolefin-, polyamide- and polyester-based materials.
[6] The method of providing a processed marine product for refrigeration storage according to any one of [1] to [5], wherein the container has a tray type structure.
[7] The method of providing a processed marine product for refrigeration storage according to [6], wherein the tray is a plurality-connected type tray, connected by long sides and/or by short sides of an upper portion of a rectangular parallelepiped shape.
[8] The method of providing a processed marine product for refrigeration storage according to [7], wherein the tray is a two to four-connected type tray.
[9] The method of providing a processed marine product for refrigeration storage according to any one of [1] to [8], wherein the refrigerated processed marine product is selected from scallops, oysters, saury, mackerel, Japanese horse mackerel, sardine, flatfish, cod, salmon, cod roe, soft roe, sea urchin roe, salmon roe, wakame seaweed, mechabu and Sargassum.
[10] The method of providing a processed marine product for refrigeration storage according to any one of [1] to [9], wherein the refrigerated processed marine product is refrigerated by a cell alive system (CAS) refrigeration technique.

### Advantageous Effects of Invention

By storing a marine product subjected to refrigerating processing in a transparent or translucent tray type container which allows refrigerated storage, without using a packing material, and distributing/providing the product, it is possible for a user to store the product in a freezer as it is, without a disposal treatment of the packing material, and to thaw and use the product.

In addition, by dividing a tray into plural parts and providing the tray as one pack (1 packing), it is possible to use a smaller amount than the amount in the distribution state. Here, since the weight in the distribution stage is identical to the original weight, purchase is possible without paying extra costs.

In addition, the container is transparent or translucent so that the content can be visually recognized, the residual amount can be visually easily confirmed in a state of being placed in a stocker.

### BRIEF DESCRIPTION OF DRAWINGS

FIG. 1 is a photograph of an example of a two-connected type container formed of a translucent plastic material used in a method of the present invention.

FIG. 2 is a photograph that illustrates a state where refrigerated scallop adductor muscles are stored in the container of FIG. 1, and the amount of the content can he visually recognized from the outside.

### DESCRIPTION OF EMBODIMENTS

A container both for sale and for refrigeration storage used in a method of providing a processed marine product for refrigeration storage according to the present invention is transparent or translucent, and is formed of a plastic material so that a residual amount of the processed marine product therein can be visually confirmed from the outside. This container may be manufactured by molding a plastic material having a transparency which allows the residual amount therein to be visually recognized from the outside.

This plastic material is a material which can be molded into a transparent or translucent container, and though not particularly limited to, the material may include each of the based material of polyolefin, polyamide, polystyrene and polyester. Here, “based material” is an expression describing a main resin component, and refers to containing more than 50% by mass of the main resin component, or 100% by mass of the main resin. Specific examples of the resin materials may include each known based resin such as polyethylene (PE), polypropylene (PP), polyethylene terephthalate (PET), and polystyrene (PS).

It is more preferred that the container both for sale and for refrigeration storage to be used in the method of providing a processed marine product for refrigeration storage according to the present invention is a container molded in accordance with a resin specification of a cold-resistant grade, for refrigeration (freezing) storage. Here, the resin of “a cold-resistant grade” may include a resin material having an embrittlement temperature less than −5° C., preferably less than −10° C., more preferably less than −20° C., in addition to the resins recommended by manufacturers for cold-resistance. Here, the embrittlement temperature refers to a temperature at which when plastics (resin) and the like are cooled, the plastics lose their plasticity or ductility to reduce strength to mechanical impact, thereby being easily broken, and 50% of specimens are broken. The embrittlement temperature of the resin material to be preferably used is, for example, −70 to −80° C. for PE, −20° C. for PPO, −20° C. for ABS, and −30 to −50° C. for nylon 66.

A general purpose polystyrene (GPPS) which is a polymer of styrene only, and amorphous, colorless and transparent has an embrittlement temperature more than 0° C. and is fragile, however, GPPS can be suitably used as a rubber component-added impact resistant PS (HIPS), a styrene-acrylonitrile copolymer resin, or a resin including acrylonitrile-butadiene-styrene (ABS).

PET has many amorphous regions, is hardly restricted by crystallization, and does not become brittle even at a temperature lower than a glass transition temperature

In addition, as the container both for sale and for refrigeration storage used in the method of providing the processed marine product for refrigeration storage according to the present invention, it is preferred to use a molded container composed of a resin having a barrier property which is used for lowering oxygen permeability. Freshness deterioration of fish is different depending on the kind of fish, and for example, it is known that freshness deterioration of red fish is faster, and freshness deterioration of white fish such as a sea bream is slower. However, since in general, freshness deterioration of blood or fat easily proceeds by contact with oxygen, it is preferred to select (1) a molded product using a resin having an oxygen barrier property, (2) a laminate/multilayer molded product, or (3) a product having a surface coated with an organic or inorganic material, as the resin material of the container.

In addition, in the method of providing a processed marine product for refrigeration storage according to the present invention, it is preferred to perform packaging treatment by removing air in the container, and filling the container with nitrogen and sealing it for storage, after storing a refrigerated product in a container, in order to prevent blood or fat of fish in the container from contacting oxygen even in a refrigerated state, in addition to selecting the material of the container both for sale and for refrigeration storage. This system is called, for example, modified atmosphere packaging (MAP/gas substitution packaging), and since packaging can be performed without a change of atmosphere by filling nitrogen, oxygen is prevented, and also good taste is maintained, so that long-term storage is possible.

As a film material of a lid part for packaging the container, a resin film described in any one of the above (1) to (3), or other known resin films having a high oxygen barrier property are adopted.

For the container used in the present invention, a container and/or the lid part formed of polyvinylidene chloride PDC), an ethylene-vinyl alcohol copolymer (EVOH), metaxylene adipamide (MXD6 nylon), and the like, may be used, in addition to the above resin.

Though the shape of the container is not particularly limited, a rectangular parallelepiped-shaped tray is preferred. The container has a size suitable for storing preserving the refrigerated processed marine product in a freezer as it is, after a person who handles the processed marine product according to the present invention (a person skilled in the art) sells/purchases the refrigerated processed marine product in the distribution process. Specifically, a container having a desired size within a range of a length (a long side of the rectangular parallelepiped-shaped tray) of 80 to 380 mm, a width (a short side of the rectangular parallelepiped-shaped tray) of 80 to 265 mm, and a height of 30 to 1.10 mm is available from existing molding manufacturers.

A plurality of trays may be connected. Specifically, a plurality-connected type tray may be mentioned, in which the trays are connected by long sides and/or by short sides of an upper portion of a rectangular parallelepiped shape. Specific examples thereof include two or three trays connected by the long sides, and four trays connected by the long sides and by the short sides, but are not limited thereto.

In a connecting portion of the plurality-connected tray container, it is preferred that a recessed structure is formed by making the thickness of the resin smaller than other portions, so that a user can cut the connecting portion simply by hands without using a cutting means such as scissors. In addition, it is preferred to bond a packing film of the lid portion on the connecting portion to form a structure having a plurality of recessed portions.

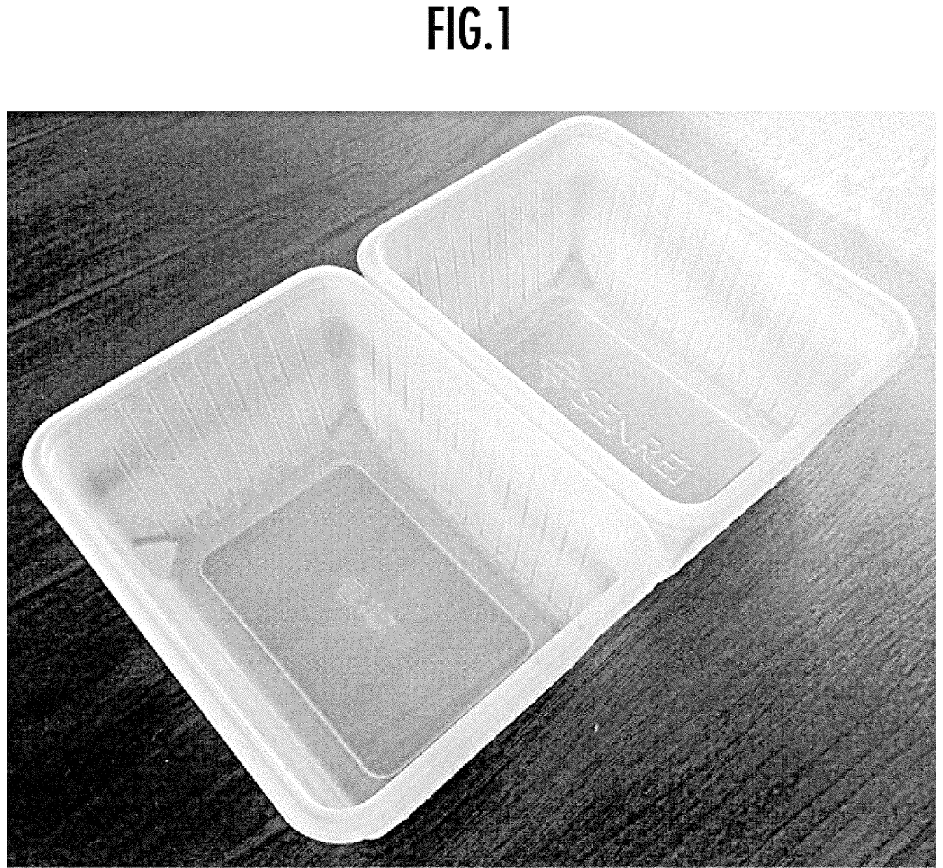

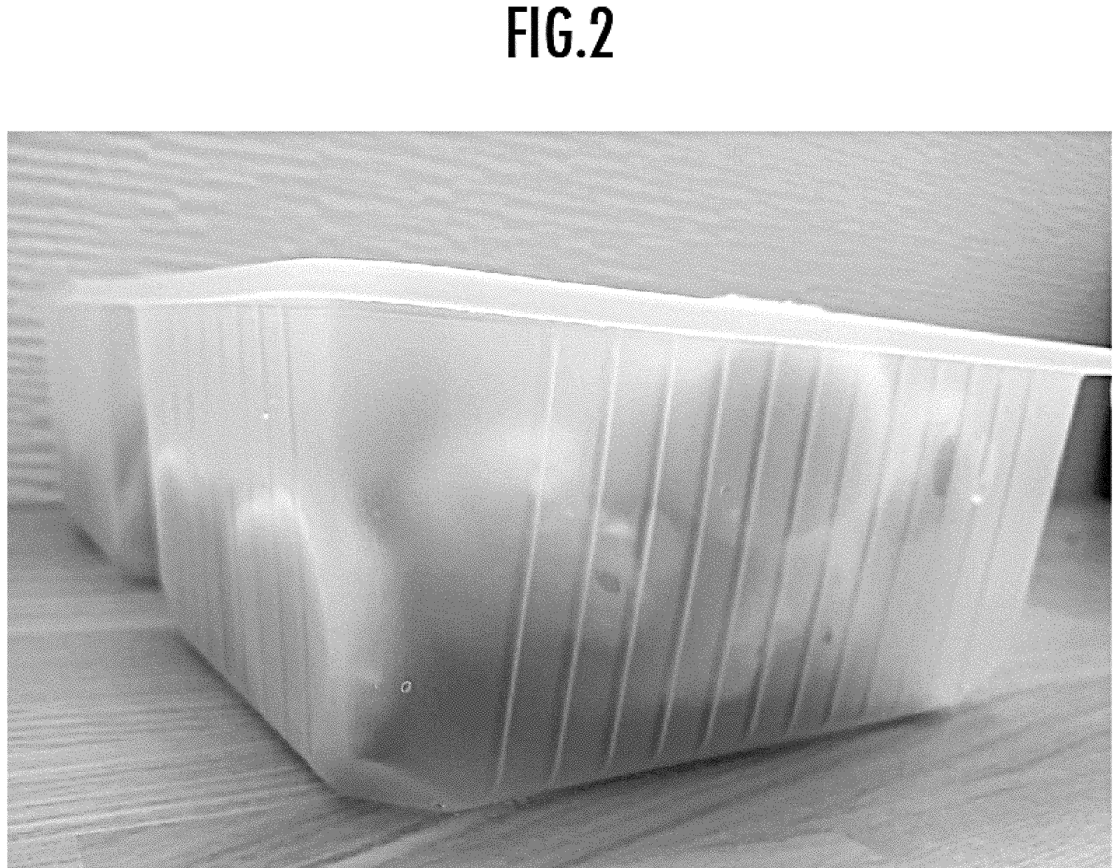

A photograph of a two-connected type tray container formed of a translucent polypropylene material, in which the trays are connected by long sides is shown in FIG. 1. FIG. 2 is a photograph illustrating a state where the scallop adductor muscles are placed in the tray container of FIG. 1, and the amount of the scallop adductor muscles can be confirmed from the outside of the translucent container.

The refrigerated processed marine product to be the subject of the present invention is not particularly limited, and also includes a refrigerated product which has been cooked by heating processing, however, the method of providing of the present invention is particularly advantageous for a refrigerated processed marine product which can be eaten raw, and in particular, a product which is refrigerated and stored at −30° C. or less is the preferred refrigerated processed marine product which can be eaten raw that. This refrigerated processed marine product is not particularly limited, but for example, may include shellfish (with shell and peeled) such as scallops and oysters, fish (whole and fillet) such as saury, mackerel, Japanese horse mackerel, sardine, flatfish, cod and salmon, fish eggs such as cod roe, soft roe, sea urchin roe and salmon roe, seaweeds such as wakame seaweed, Sargassum, mechabu (a root part of wakame seaweed). Among them, scallops which are aquacultured in Onagawahama port, Onagawa-cho Oshika-gun, Miyagi-ken where the present applicant is located, sashimi slices (fillet) such as saury, mackerel and sardine, of which the amount of catch is unusual in the whole country, and wakame seaweeds are preferred.

The method of refrigerating a processed marine product to be subjected is not limited, however, refrigeration by a cell alive system (CAS) method which maintains good taste for a long period when fresh seafood is freezed, is preferred.

### EXAMPLES

Hereinafter, the method of providing/using a processed marine product according to the present invention will be described in more detail, by way of the Example, and the Comparative Examples, and at the same time, verified by way of the operational effect of the present invention. These Examples are only exemplification and specific descriptions, and the present invention is not limited to these examples.

### Example 1

In a rectangular parallelepiped tray container (length: 180 mm, width: 284 mm, height: 74 mm, two-connected type container) made of cold-resistant PP (embrittlement temperature of −30° C.), formed of a translucent plastic material, illustrated in FIG. 1, 1 kg of refrigerated scallop adductor muscles, which are a refrigerated processed marine product by the CAS method, was directly stored in the above-described container, using an automatic tray sealer, SEALPAC (registered trademark) (available from Nakamura Sangyo Co., Ltd.), MAP-packaged under the air, and supplied to consumers by common refrigeration transportation means. As a packaging film at the time of MAP packaging, a three-layer structure film (base film: PP-based EP (embrittlement temperature of −18° C.), intermediate film: PA (embrittlement temperature of −40° C.), and top film: PET (embrittlement temperature of −40° C.)) was used. The consumers stored the purchased refrigerated processed marine product as it is in the container in a freezer, or after receiving the two-connected type container, cut the connected container into separated containers by hands, unpacked the two containers independently, and took out an appropriate amount from the container and displayed it in a shop for sale, or used an appropriate amount for cooking.

A satisfaction degree of users (customers) was evaluated by heating, based on the following three-step standard:

⊙: very easy to use with an appropriate amount efficiently, since the residual amount is easily seen in the stocker,

∘: easy to use, as described above, and

Δ: hard to use.

The results are shown in Table 1.

### Example 2

The product was directly stored in the container using the automatic tray sealer of Example 1 and the process was carried out in the same manner as in Example 1, except that MAP-packaged not under the air but with nitrogen inclusion, thereby obtaining the evaluation listed in Table 1.

### Example 3

The process was carried out in the same manner as in Example 1, except that the refrigerated scallop adductor muscles which is the refrigerated processed marine product by the CAS method were replaced with the refrigerated scallop adductor muscles by a non-CAS method (usual freezing) (frozen scallop adductor muscles by a conventional freezing means), thereby obtaining the evaluation listed in Table 1.

### Example 4

The process was carried out in the same manner as in Example 1, except that 1 kg of the refrigerated scallop adductor muscles was replaced with 1 kg of saury thereby obtaining the evaluation listed in Table 1.

### Example 5

The process was carried out in the same manner as in Example 2, except that 1 kg of the refrigerated scallop adductor muscles was replaced with 1 kg of saury thereby obtaining the evaluation listed in Table 1.

### Example 6

The process was carried out in the same manner as in Example 3, except that 1 kg of the refrigerated scallop adductor muscles was replaced with 1 kg of saury thereby obtaining the evaluation listed in Table 1.

### Example 7

The process was carried out in the same manner as in Example 1, except that 1 kg of the refrigerated scallop adductor muscles was replaced with 1 kg of mackerel fillets, thereby obtaining the evaluation listed in Table 1.

### Example 8

The process was carried out in the same manner as in Example 2, except that 1 kg of the refrigerated scallop adductor muscles was replaced with 1 kg of mackerel fillets, thereby obtaining the evaluation listed in Table 1.

### Example 9

The process was carried out in the same manner as in Example 3, except that 1 kg of the refrigerated scallop adductor muscles was replaced with 1 kg of mackerel fillets, thereby obtaining the evaluation listed in Table 1.

### Comparative Example 1

1 kg of the scallop adductor muscles refrigerated processed by a non-CAS method (usual freezing) was placed in a plastic bag for storage, which was placed in a decorative box, and provided for a user. The user took the plastic bag out of the decorative box, took the scallop adductor muscles out of the plastic bag and transferred the scallop adductor muscles to another container for storage, stored the container in a freezer, and took out an appropriate amount of scallop adductor muscles at a proper time and used the amount for cooking. The plastic bag or the decorative box was discarded by a common method. A satisfaction degree of users (customers) was evaluated by heating, based on the following three-step standard:

⊙: very easy to use with an appropriate amount efficiently since the residual amount is easily seen in the stocker,

∘: easy to use, as described above, and

Δ: hard to use, having a lot of waste.

The results are shown in Table 1.

### Comparative Example 2

The process was carried out in the same manner as in Comparative Example 1, except that 1 kg of the refrigerated scallop adductor muscles was replaced with 1 kg of saury fillets, thereby obtaining the evaluation listed in Table 1.

### Comparative Example 3

The process was carried out in the same manner as in Comparative Example 1, except that 1 kg of the refrigerated scallop adductor muscles was replaced with 1 kg of mackerel fillets, thereby obtaining the evaluation listed in Table 1.

TABLE 1

| | | | | | Customer |
|---|---|---|---|---|---|
| | | Refrigerated | | | satisfaction degree |
| | | processed marine | Refrigeration | | of method of |
| Examples | Storage container | food material | means | Atmosphere | providing |
| Example 1 | Tray | Scallop adductor | Refrigeration by | Air | ⊙ |
| | | muscles | CAS method | | |
| Example 2 | Same as above | Same as above | Same as above | Nitrogen inclusion | ⊙ |
| Example 3 | Same as above | Same as above | Refrigeration by | Air | ◯ |
| | | | non-CAS method | | |
| Example 4 | Same as above | Saury fillet | Refrigeration by | Air | ⊙ |
| | | | CAS method | | |
| Example 5 | Same as above | Same as above | Same as above | Nitrogen inclusion | ⊙ |
| Example 6 | Same as above | Same as above | Refrigeration by | Air | ◯ |
| | | | non-CAS method | | |
| Example 7 | Same as above | Mackerel fillet | Refrigeration by | Air | ◯ |
| | | | CAS method | | |
| Example 8 | Same as above | Same as above | Same as above | Nitrogen inclusion | ⊙ |
| Example 9 | Same as above | Same as above | Refrigeration by | Air | ◯ |
| | | | non-CAS method | | |
| Comparative | Placed in a bag, | Scallop adductor | Refrigeration by | Air | Δ |
| Example 1 | decorative box | muscles | non-CAS method | | |
| Comparative | Same as above | Saury fillet | Refrigeration by | Air | Δ |
| Example 2 | | | non-CAS method | | |
| Comparative | Same as above | Mackerel fillet | Refrigeration by | Air | Δ |
| Example 3 | | | non-CAS method | | |

1. A method of providing a processed marine product for refrigeration storage, the method comprising:
directly storing a refrigerated processed marine product in a container formed of a plastic material, having a transparency to allow an amount of the refrigerated processed marine product stored therein to be visually recognized from outside, and supplying the product to a consumer, wherein
the refrigerated processed marine product is stored in a freezer, and thawed for use.

2. A method of providing a processed marine product for refrigeration storage, the method comprising:
directly storing a refrigerated processed marine product in a container formed of a plastic material of a cold-resistant grade, having a transparency to allow an amount of the refrigerated processed marine product stored therein to be visually recognized from outside, and supplying the product to a consumer, wherein
the refrigerated processed marine product is stored in a freezer, and thawed for use.

3. A method of providing a processed marine product for refrigeration storage, the method comprising:
directly storing a refrigerated processed marine product in a container formed of a plastic material having an embrittlement temperature less than −5° C., having a transparency to allow an amount of the refrigerated processed marine product stored therein to be visually recognized from outside, and supplying the product to a consumer, wherein
the refrigerated processed marine product is stored in a freezer, and thawed for use.

4. The method of providing a processed marine product for refrigeration storage according to claim 1, wherein
the refrigerated processed marine product is directly stored in the container formed of the plastic material, and
the container is filled with nitrogen by gas substitution packaging, and supplied to a consumer.

5. The method of providing a processed marine product for refrigeration storage according to claim 1, wherein the plastic material is selected from polyolefin-, polyamide- and polyester-based materials.

6. The method of providing a processed marine product for refrigeration storage according to claim 1, wherein the container has a tray type structure.

7. The method of providing a processed marine product for refrigeration storage according to claim 6, wherein the tray is a plurality-connected type tray, connected by long sides and/or by short sides of an upper portion of a rectangular parallelepiped shape.

8. The method of providing a processed marine product for refrigeration storage according to claim 7, wherein the tray is a two to four-connected type tray.

9. The method of providing a processed marine product for refrigeration storage according to claim 1, wherein the refrigerated processed marine product is selected from scallops, oysters, saury, mackerel, Japanese horse mackerel, sardine, flatfish, cod, salmon, cod roe, soft roe, sea urchin roe, salmon roe, wakame seaweed, mechabu and Sargassum.

10. The method of providing a processed marine product for refrigeration storage according to claim 1, wherein the refrigerated processed marine product is refrigerated by a cell alive system (CAS) refrigeration technique.
